(19) United States
(12) Patent Application Publication
(10) Pub. No.: US 2025/0058488 A1
(43) Pub. Date: Feb. 20, 2025

(54) AUTOMATIC DIE RUBBER INSTALLING MACHINE FOR FLAT DIE BOARD AND AUTOMATIC DIE RUBBER INSTALLING METHOD FOR FLAT DIE BOARD

(71) Applicant: DONGGUAN CITY YISONG HIGH TECHNOLOGY CO., LTD., Dongguan (CN)

(72) Inventors: Yihui CHI, Dongguan (CN); Qingsong FU, Dongguan (CN)

(73) Assignee: DONGGUAN CITY YISONG HIGH TECHNOLOGY CO., LTD., Dongguan (CN)

(21) Appl. No.: 18/805,596

(22) Filed: Aug. 15, 2024

(30) Foreign Application Priority Data
Aug. 16, 2023 (CN) 202311029685.8
Sep. 15, 2023 (CN) 202311192832.3
Apr. 25, 2024 (CN) 202410506614.0
May 10, 2024 (CN) 202410574909.1

(51) Int. Cl. B26D 7/27; B26F 1/44

(52) U.S. Cl. CPC B26D 7/27; B26F 1/44; B26F 2001/4427; B26F 2001/4454

(57) ABSTRACT

An automatic die rubber installing machine for a flat die board and an automatic die rubber installing method for a flat die board are provided. The automatic die rubber installing machine for the flat die board includes: a machine table, where an elastic material cutting station and a flat die board placement station are provided on the machine table; an X/Y-axis feeding mechanism provided on the machine table, and located above the elastic material cutting station and the flat die board placement station; a Z-axis feeding mechanism provided on the X/Y-axis feeding mechanism; and an installing work portion provided at a movement output end of the Z-axis feeding mechanism, and facing toward the elastic material cutting station and the flat die board placement station. The installing work portion includes a cutting tool head and a grabbing tool head that are configured to rotate around a Z axis.

### CROSS REFERENCE TO THE RELATED APPLICATIONS

This application is based upon and claims priority to Chinese Patent Applications No. 202311029685.8, filed on Aug. 16, 2023; No. 202311192832.3, filed on Sep. 15, 2023; No. 202410506614.0, filed on Apr. 25, 2024; and No. 202410574909.1, filed on May 10, 2024; the entire contents of which are incorporated herein by reference.

### TECHNICAL FIELD

The present disclosure relates to the technical field of die boards, and in particular to an automatic die rubber installing machine for a flat die board and an automatic die rubber installing method for a flat die board.

### BACKGROUND

Flat die boards are used frequently in the packaging industry. Blades are provided on flat die boards. Through the blade, the packaging material is cut or creased as required.

Usually, an elastic material is provided on die boards at two sides of a blade point. The elastic material is installed on the die boards and located at the two sides of the blade point, such that the blade point is covered by the elastic material. Only when the elastic material is compressed in cutting is the blade point exposed. In this way, the blade point is protected, and the blade point is less impacted when nonworking to not cause the damage. On the other hand, after the packaging material is cut by the blade point, the compressed elastic material is restored to eject the packaging material, thereby facilitating separation of the packaging material from the blade point.

Conventionally, the elastic material is manually cut and manually installed on the die boards at the two sides of the blade point. This is inefficient and time-consuming. Moreover, the manual cutting often makes quality unreliable. When the cut size is unqualified, the elastic material is wasted greatly. Due to the sharp blade point, when the elastic material is installed, the operator is cut easily to cause potential safety hazards.

Therefore, an automatic die rubber installing machine capable of automatically cutting the elastic material and installing the elastic material on the flat die board is desirable in the industry.

### SUMMARY

### (I) Technical Problems to be Solved

In view of the above defects and shortages in the prior art, the present disclosure provides an automatic die rubber installing machine for a flat die board and an automatic die rubber installing method for a flat die board, to solve technical problems of a low efficiency and a potential safety hazard in manual cutting and manual installing of the elastic material on the die board.

### (II) Technical Solutions

To achieve the above objective, main technical solutions of the present disclosure are as follows:

According to a first aspect, an embodiment of the present disclosure provides an automatic die rubber installing machine for a flat die board, including:
a machine table, where an elastic material cutting station and a flat die board placement station are provided on the machine table;
an XY-axis feeding mechanism provided on the machine table, and located above the elastic material cutting station and the flat die board placement station;
a Z-axis feeding mechanism provided on the XY-axis feeding mechanism; and
an installing work portion provided at a movement output end of the Z-axis feeding mechanism, configured to move up and down under drive of the Z-axis feeding mechanism, and configured to move between the elastic material cutting station and the flat die board placement station under drive of the XY-axis feeding mechanism,
where the installing work portion includes a cutting tool head and a grabbing tool head; both the cutting tool head and the grabbing tool head are configured to rotate around a Z axis; the cutting tool head is configured to cut an elastic material into an elastic material strip at the elastic material cutting station; and the grabbing tool head is configured to grab the elastic material strip, move the elastic material strip from the elastic material cutting station to the flat die board placement station, and fix the elastic material strip at a to-be-installed position of a die board at the flat die board placement station.

Optionally, the grabbing tool head includes a first revolving seat; a pin work portion driven by a first motor and rotating around the Z axis is provided on the first revolving seat; the pin work portion includes a discharge cylinder, a pin support, and a grabbing actuation end; the pin support is connected to the first motor; the discharge cylinder is provided on the pin support; the grabbing actuation end is fixedly connected to an output shaft of the discharge cylinder; and an avoidance position configured to allow the grabbing actuation end to extend and retract up and down is provided at a bottom of the pin support.

Optionally, the pin work portion further includes a pressing cylinder and a pressing plate; the pressing cylinder is provided on the pin support; the pressing plate is fixedly connected to an output shaft of the pressing cylinder; and a through hole configured to avoid the bottom of the pin support when the pressing plate extends and retracts up and down is formed in the pressing plate.

Optionally, the grabbing actuation end includes a pin plate and pins provided at a bottom of the pin plate; and the pin plate is fixedly connected to the output shaft of the discharge cylinder.

Optionally, the pins are fixedly provided at the bottom of the pin plate; and alternatively, there are two or more pins, and at least one of the pins is movable left and right at the bottom of the pin plate.

Optionally, the installing work portion further includes a detection tool head; the detection tool head includes a rotary detection motor and a probe; a rotating shaft of the rotary detection motor is provided horizontally; the probe is fixedly connected to the rotating shaft of the rotary detection motor and crossed with the rotating shaft of the rotary detection motor; and a detection head is provided at a tail end of the probe.

Optionally, the automatic die rubber installing machine for a flat die board further includes a detection tool head lifting mechanism; the detection tool head lifting mechanism is provided at the movement output end of the Z-axis feeding mechanism; and the rotary detection motor is provided at a movement output end of the detection tool head lifting mechanism.

Optionally, the installing work portion further includes a gluing tool head; the gluing tool head is liftable relative to the Z-axis feeding mechanism; and the gluing tool head is configured to perform a gluing operation on an installing position between the elastic material and the flat die board.

Optionally, a top-opened glue container is further provided on the machine table; the glue container is located at a position where the grabbing tool head is allowed to reach; and the grabbing actuation end of the grabbing tool head is configured to extend into the glue container.

Optionally, the cutting tool head includes a second revolving seat, a vibration drive assembly, a cutter, and a second motor; the cutter is rotatably provided on the second revolving seat; the vibration drive assembly is provided on the second revolving seat, and connected to the cutter; the vibration drive assembly is configured to drive the cutter to vibrate up and down; the second motor is provided on the second revolving seat, and connected to the cutter; and the second motor is configured to drive the cutter to rotate around the Z axis.

According to a second aspect, the present disclosure provides an automatic die rubber installing method for a flat die board, where the automatic die rubber installing method for a flat die board is realized based on an automatic die rubber installing machine for a flat die board; the automatic die rubber installing machine for a flat die board includes a machine table and an installing work portion; an elastic material cutting station and a flat die board placement station are provided on the machine table; the installing work portion is movably provided on the machine table, and faces toward the elastic material cutting station and the flat die board placement station; and the installing work portion includes a cutting tool head and a grabbing tool head that are configured to rotate around a Z axis; and
the automatic die rubber installing method for a flat die board includes the following steps:
a cutting step: moving the cutting tool head to the elastic material cutting station to cut an elastic material into an elastic material strip of a preset shape and a preset size; and
an installing step: allowing the grabbing tool head to move a grabbed elastic material strip to a position above a to-be-installed position of a die board at the flat die board placement station;
and moving down the grabbing tool head, placing the elastic material strip at the to-be-installed position of the die board and pressing the elastic material strip, moving up the grabbing tool head, and releasing the elastic material strip.

Optionally, the automatic die rubber installing method for a flat die board further includes a gluing step between the cutting step and the installing step; and
the gluing step is realized based on a gluing tool head included in the installing work portion, and includes: moving the gluing tool head to the flat die board placement station, and performing a gluing operation on the to-be-installed position of the die board; and alternatively,
the gluing step is realized based on a top-opened glue container provided on the machine table, and includes: allowing the grabbing tool head to grab the elastic material strip, and extend the elastic material strip into the glue container, where a glue is dipped to a bottom and/or a part of a periphery of the elastic material strip.

Optionally, the grabbing tool head includes a pin support, as well as a discharge cylinder and a grabbing actuation end that are supported on the pin support; and the grabbing actuation end is fixedly connected to an output shaft of the discharge cylinder; and
the moving down the grabbing tool head, placing the elastic material strip at the to-be-installed position of the die board and pressing the elastic material strip comprise: extending out the grabbing actuation end at a bottom of the pin support to grab the elastic material strip; moving down the grabbing tool head to drive the grabbing actuation end to place the elastic material strip at the to-be-installed position of the die board; allowing the discharge cylinder to drive the grabbing execution end to move up to a position higher than the bottom of the pin support; and continuously moving down the grabbing tool head, such that the pin support is driven to move down and the bottom of the pin support is pressed on the elastic material strip.

Optionally, the automatic die rubber installing method for a flat die board further includes a detecting step before the cutting step;
the detecting step is realized based on a detection tool head included in the installing work portion; the detection tool head includes a rotary detection motor and a probe; a rotating shaft of the rotary detection motor is provided horizontally; the probe is fixedly connected to the rotating shaft of the rotary detection motor and crossed with the rotating shaft of the rotary detection motor; and a detection head is provided at a tail end of the probe; and
the detecting step includes:
S1: moving the detection tool head, pressing the detection head on an upper surface of a target flat die board at the flat die board placement station, and recording a rotating position of the rotating shaft of the rotary detection motor as an initial position;
S2: horizontally moving the detection tool head, such that the detection head slides over a cutter seam, recording a rotating position of the rotating shaft of the rotary detection motor in this process, obtaining a rotating position curve, and determining a point position on the cutter seam according to a peak in the rotating position curve;
S3: repeating the S2 to obtain two point positions on the same cutter seam, thereby obtaining a centerline parameter of the cutter seam; and repeating the S2 and the S3 to obtain centerline parameters of at least one pair of crossed cutter seams; and
S4: comparing the centerline parameters of the at least one pair of crossed cutter seams with a parameter of a cutter seam of the target flat die board in a database to obtain an actual position of the target flat die board and an actual position of the cutter seam.

Optionally, the automatic die rubber installing method for a flat die board further includes a detecting step before the cutting step;
the detecting step is realized based on a detection tool head included in the installing work portion; the detection tool head includes a rotary detection motor and a probe; a rotating shaft of the rotary detection motor is provided horizontally; the probe is fixedly connected to the rotating shaft of the rotary detection motor and crossed with the rotating shaft of the rotary detection motor; and a detection head is provided at a tail end of the probe; and
the detecting step includes:
A1: moving the detection tool head, and after the detection head contacts a surface of the machine table, obtaining a height position Z₁ of the rotary detection motor and a deflection angle W₁ of the rotating shaft of the rotary detection motor;
A2: moving the detection tool head, and after the detection head contacts an upper surface of the flat die board, obtaining a height position Z₂ of the rotary detection motor and a deflection angle W₂ of the rotating shaft of the rotary detection motor; and
A3: assuming that a length between a center of the detection head to a center of the rotating shaft of the rotary detection motor is L, a Z-direction distance between the center of the detection head and the center of the rotating shaft of the rotary detection motor in the A1 is H₁, and a Z-direction distance between the center of the detection head and the center of the rotating shaft of the rotary detection motor in the A2 is H₂, then obtaining a height H=(Z₂−H₂)−(Z₁−H₁) of the flat die board.

### (III) Beneficial Effects

The present disclosure has the following beneficial effects: The automatic die rubber installing machine for a flat die board provided by the present disclosure is structurally reasonable and skillful. By integrating the cutting tool head and the grabbing tool head on the machine table, the present disclosure automatically cuts and grabs the elastic material, and places the elastic material strip on the flat die board. Without manual intervention, the present disclosure achieves the high production efficiency, reduces the production cost, and prevents the potential safety hazard of the manual operation.

### BRIEF DESCRIPTION OF THE DRAWINGS

FIG. 1 is a schematic structural view of an automatic die rubber installing machine for a flat die board according to Embodiment 1 of the present disclosure;

FIG. 2 is a schematic structural view after an elastic material strip is installed on a flat die board according to Embodiment 1 of the present disclosure;

FIG. 3 is an enlarged view of A shown in FIG. 2;

FIG. 4 is a schematic structural view of a cutting tool head according to Embodiment 1 of the present disclosure, where a vibration drive assembly is a vibration motor;

FIG. 5 is a schematic structural view of a cutting tool head according to Embodiment 1 of the present disclosure, where a vibration drive assembly is a pneumatic component;

FIG. 6 is a schematic structural view of a grabbing tool head from a first viewing angle according to Embodiment 1 of the present disclosure;

FIG. 7 is a schematic structural view of a grabbing tool head from a second viewing angle according to Embodiment 1 of the present disclosure;

FIG. 8 is a schematic structural view of a pin work portion according to Embodiment 1 of the present disclosure, where there are two pins at a grabbing actuation end;

FIG. 9 is a schematic sectional view of the pin work portion shown in FIG. 8;

FIG. 10 is a schematic structural view of a pin work portion according to Embodiment 1 of the present disclosure, where there are three pins at a grabbing actuation end;

FIG. 11 is a schematic structural view of a pin work portion according to Embodiment 1 of the present disclosure, where there are four pins at a grabbing actuation end;

FIG. 12 is a schematic structural view of a pin work portion according to Embodiment 1 of the present disclosure, where there are two pins at a grabbing actuation end, one pin is fixedly provided at a bottom of a pin plate, and the other pin is movable left and right at the bottom of the pin plate;

FIG. 13 is a schematic structural view of a gluing tool head according to Embodiment 1 of the present disclosure;

FIG. 14 is a schematic structural view of an installing work portion according to Embodiment 1 of the present disclosure;

FIG. 15 is a schematic structural view of an automatic die rubber installing machine for a flat die board according to Embodiment 3 of the present disclosure, where an elastic material cutting station and a flat die board placement station are provided left and right, and a glue container is provided between the elastic material cutting station and the flat die board placement station;

FIG. 16 is a schematic structural view of an automatic die rubber installing machine for a flat die board according to Embodiment 3 of the present disclosure, where an elastic material cutting station is provided at a front end, a flat die board placement station is provided at a rear end, and a glue container is provided at a front end of a right side of the flat die board placement station;

FIG. 17 is a schematic structural view of a glue container according to Embodiment 3 of the present disclosure;

FIG. 18 is a schematic structural view of a detection tool head according to Embodiment 5 of the present disclosure;

FIG. 19 is a flowchart that a detection head detects a cutter seam according to Embodiment 5 of the present disclosure;

FIG. 20 illustrates a rotating position curve detected by a detection head according to Embodiment 5 of the present disclosure;

FIG. 21 is a schematic view illustrating that a detection head contacts a surface of a machine table according to Embodiment 5 of the present disclosure; and

FIG. 22 is a schematic view illustrating that a detection head contacts an upper surface of a flat die board according to Embodiment 5 of the present disclosure.

### REFERENCE NUMERALS

1: machine table;
2: elastic material cutting station;
3: flat die board placement station;
4: X/Y-axis feeding mechanism;
41: sliding track, and 42: transverse support;
5: Z-axis feeding mechanism;
51: Z-axis sliding seat, 52: Z-axis sliding plate, 53: Z-axis drive motor, 54: lead screw unit,
55: grabbing tool head lifting mechanism, and 56: gluing tool head lifting mechanism;
60: shaft coupler, 61: cutting tool head, 62: grabbing tool head, 63: gluing tool head, and
64: detection tool head;
611: second revolving seat, 612: vibration motor, 613: cutter, 614: second motor, 615: floating pressure sleeve, 616: first synchronizing wheel, 617: second synchronizing wheel, and 618: pneumatic component;
621: first revolving seat, 622: first motor, 623: discharge cylinder, 624: pin plate, 625: pin support, 626: pressing cylinder, 627: pressing plate, 628: pin, and 629: motor mounting seat;
6210: locating flange, 6211: directing groove, 6212: guide sleeve, and 6213: guide rod;
6251: avoidance position;
6271: through hole;
631: valve body, 632: glue injection cup, 634: tube, 635: adjustment valve, 636: air outlet connector, 637: air return connector, 638: connecting nut, and 639: glue outlet nozzle;
641: rotary detection motor, 642: probe, 643: rotating shaft, 644: detection head, 645: lifting platform, and 646: lifting detection motor;
7: flat die board;
71: sponge strip, and 72: blade point;
8: glue container; and
10: pin work portion.

### DETAILED DESCRIPTION OF THE EMBODIMENTS

To facilitate a better understanding of the present disclosure, the present disclosure is described in detail below with reference to the accompanying drawings and specific implementations.

### Embodiment 1

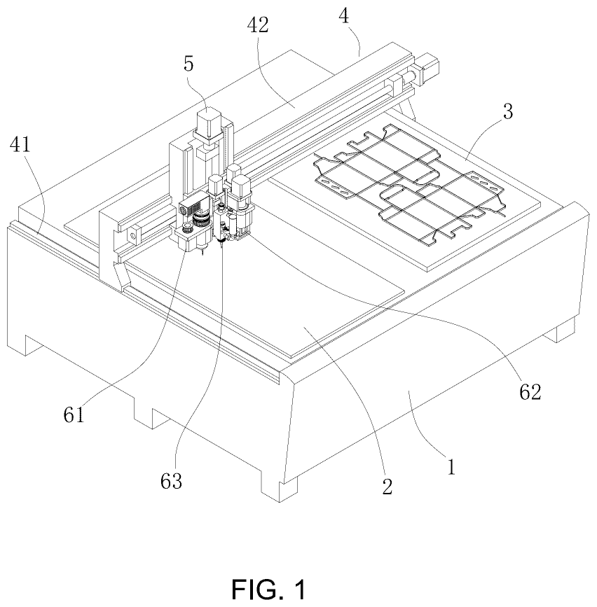

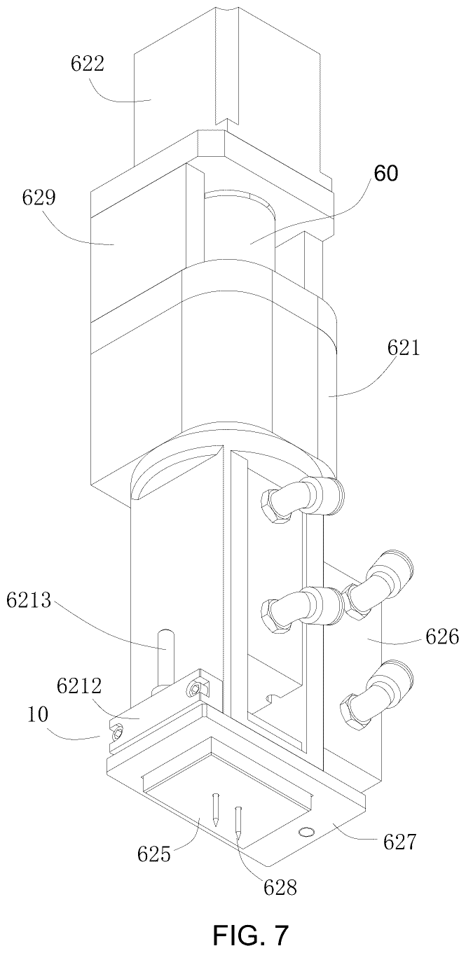

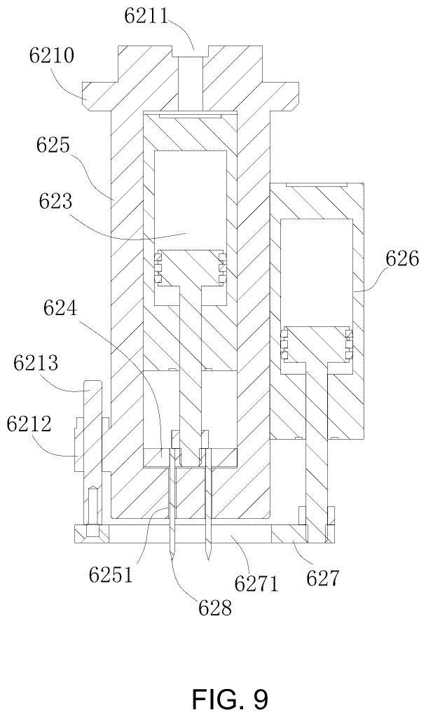

As shown in FIG. 1 to FIG. 14, the embodiment provides an automatic die rubber installing machine for a flat die board, including: machine table 1, X/Y-axis feeding mechanism 4, Z-axis feeding mechanism 5, and an installing work portion.

Elastic material cutting station 2 and flat die board placement station 3 are provided on the machine table 1.

The X/Y-axis feeding mechanism 4 is provided on the machine table 1, and located above the elastic material cutting station 2 and the flat die board placement station 3.

The Z-axis feeding mechanism 5 is provided on the X/Y-axis feeding mechanism 4.

The installing work portion faces toward the elastic material cutting station 2 and the flat die board placement station 3, and is provided on the Z-axis feeding mechanism 5. The installing work portion includes rotatable cutting tool head 61 and rotatable grabbing tool head 62.

As shown in FIG. 1, in the embodiment, two sides of the machine table 1 each are provided with sliding track 41, transverse support 42 is movably provided on the sliding track 41, and a transverse sliding table is movably provided on the transverse support 42, thereby forming the X/Y-axis feeding mechanism 4. The Z-axis feeding mechanism 5 is fixed on the transverse sliding table.

The elastic material cutting station 2 and the flat die board placement station 3 are provided on the machine table 1. The two stations may be adjusted according to an actual production need. The two stations may be arranged side by side in a left-right direction, and may also be sequentially arranged in a front-rear direction.

In other embodiments, a plurality of flat die board placement stations 3 may even be provided at the same time, so as to improve the installing efficiency of the flat die board, and install a plurality of flat die boards 7 in a short time.

The elastic material may be sponge, rubber, silica gel, and the like, provided that an enough elasticity can be provided to meet a use requirement. In the embodiment, the elastic material is the sponge, and the raw material is the sponge sheet. According to a shape and a size of a blade point of a blade on the flat die board 7, sponge strips 71 matching with the blade point 72 of the blade in shape and size are to be cut from the sponge sheet through the cutting tool head 61. After the sponge strips 71 are installed on the flat die board 7, the blade point 72 can be protected between the sponge strips 71.

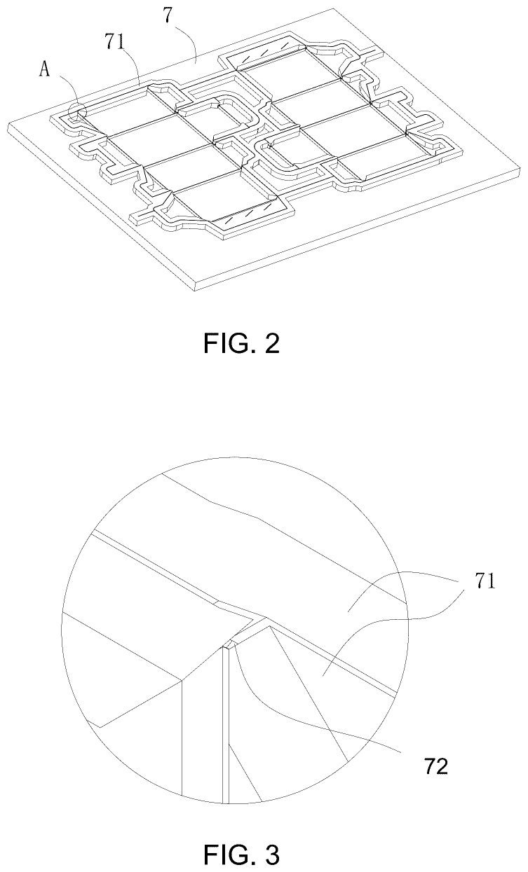

As shown in FIG. 2, on the flat die board 7, die boards at two sides of the blade point 72 are respectively installed with the sponge strips 71. A height of the sponge strip 71 is greater than a height of the blade point 72, thereby hiding the blade point 72 between the sponge strips 71 to protect the blade point 72, and ejecting a packaging material from the blade point 72 after the packaging material is cut by the blade point 72.

In the embodiment, the elastic material may be provided with a back glue to become viscous, and may also not be provided with the back glue. When the elastic material is provided with the back glue, the gluing tool head is unnecessarily used for gluing. When the elastic material is not provided with the back glue, the gluing tool head is necessarily used to perform a gluing operation on the die board.

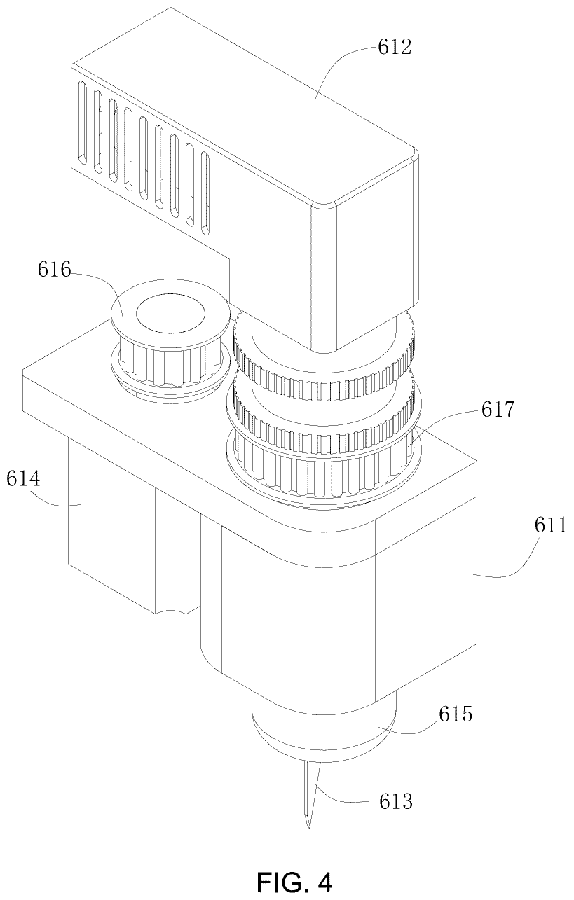

As shown in FIG. 4, the cutting tool head 61 includes second revolving seat 611. Cutter 613 driven by vibration motor 612 to vibrate up and down for cutting is provided on the second revolving seat 611. Second motor 614 configured to drive the cutter 613 to rotate is further provided on the second revolving seat 611.

The cutter 613 is rotatably provided on the second revolving seat 611. An output shaft of the vibration motor 612 is connected to the cutter 613. Floating pressure sleeve 615 is further provided at an upper end of the cutter 613. First synchronizing wheel 616 is provided on an output shaft of the second motor 614. The cutter 613 is rotatably connected to second synchronizing wheel 617. The first synchronizing wheel 616 and the second synchronizing wheel 617 are in transmission through a belt. When a cutting angle is to be adjusted, the second motor 614 works, and through transmission of the first synchronizing wheel 616, the second synchronizing wheel 617 and the belt, the cutter 613 is deflected to a desired angle. When the elastic material is to be cut, the vibration motor 612 works to drive the cutter 613 to vibrate up and down, thereby realizing a cutting operation.

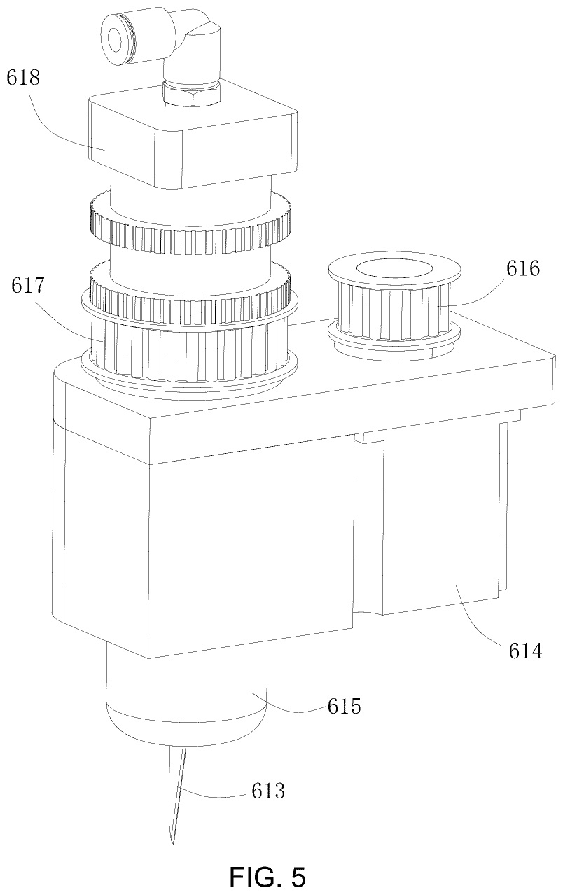

As shown in FIG. 5, in another implementation of the cutting tool head 61, the cutting tool head 61 includes second revolving seat 611. Cutter 613 driven by pneumatic component 618 to vibrate up and down for cutting is provided on the second revolving seat 611. Second motor 614 configured to drive the cutter 613 to rotate is further provided on the second revolving seat 611.

The cutter 613 is rotatably provided on the second revolving seat 611. The pneumatic component 618 is connected to the cutter 613. Floating pressure sleeve 615 is further provided at an upper end of the cutter 613. First synchronizing wheel 616 is provided on an output shaft of the second motor 614. The cutter 613 is fixedly connected to second synchronizing wheel 617. The first synchronizing wheel 616 and the second synchronizing wheel 617 are in transmission through a belt. When a cutting angle is to be adjusted, the second motor 614 works, and through transmission of the first synchronizing wheel 616, the second synchronizing wheel 617 and the belt, the cutter 613 is deflected to a desired angle. When the elastic material is to be cut, the pneumatic component 618 works to drive the cutter 613 to vibrate up and down, thereby realizing a cutting operation.

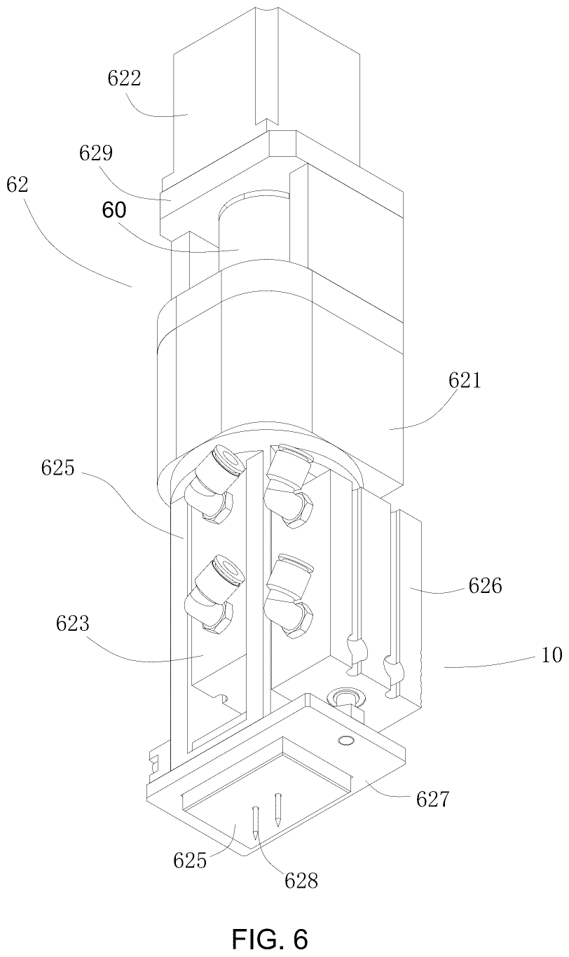

As shown in FIG. 6 to FIG. 9, the grabbing tool head 62 includes first revolving seat 621. Pin work portion 10 driven by first motor 622 to rotate is provided on the first revolving seat 621. The pin work portion 10 includes discharge cylinder 623, pin plate 624, pin support 625, pressing cylinder 626, and pressing plate 627. The pin support 625 is connected to the first motor 622. The discharge cylinder 623 is provided inside the pin support 625. The pin plate 624 is fixedly connected to an output shaft of the discharge cylinder 623. A plurality of pins 628 are provided at a bottom of the pin plate 624. Avoidance position 6251 configured to facilitate extension and retraction of each of the pins 628 is provided at a bottom of the pin support 625. The pressing cylinder 626 is provided on the pin support 625. The pressing plate 627 is fixedly connected to an output shaft of the pressing cylinder 626. Through hole 6271 matching with the bottom of the pin support 625 in size is formed in the pressing plate 627. The pressing plate 627 driven by the pressing cylinder 626 moves up to a position above the bottom of the pin support 625 or moves down to a position below the bottom of the pin support 625, such that before the pin 628 takes the elastic material, the pressing plate 627 presses the elastic material flat, and when the pin 628 drives the cut elastic material to move up, the pressing plate 627 can press the remaining elastic material, and prevent the remaining elastic material from moving up together.

In the embodiment, motor mounting seat 629 is provided at a top of the first revolving seat 621. The first motor 622 is provided on the motor mounting seat 629. An output shaft of the first motor 622 is provided downward. The output shaft of the first motor 622 is connected to the pin work portion 10 through shaft coupler 60.

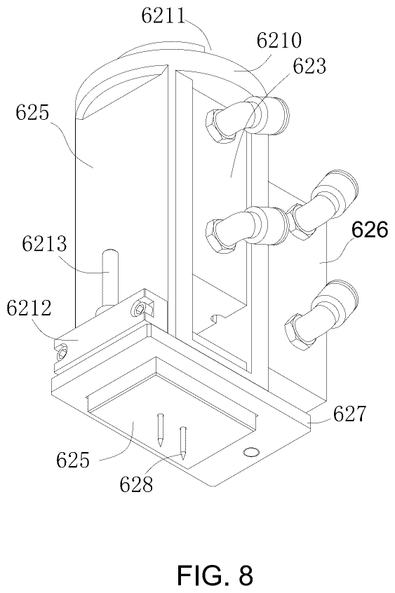

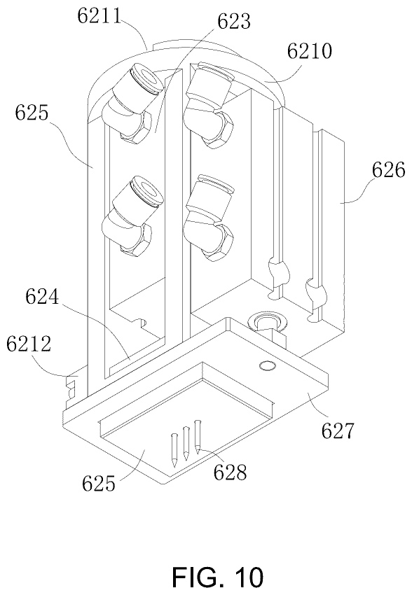

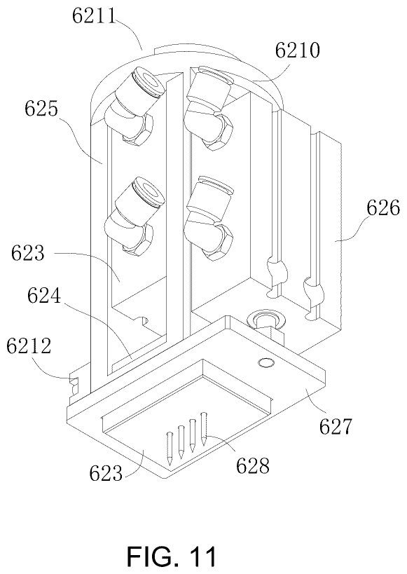

As shown in FIG. 8, FIG. 10 and FIG. 11, the discharge cylinder 623 is fixed on locating flange 6210 through the pin support 625. The locating flange 6210 is rotatable in the first revolving seat 621. Directing groove 6211 is formed in a top of the locating flange 6210. A directing bump corresponding to the directing groove 6211 is provided on a rotating shaft connected to the shaft coupler 60, such that when the first motor 622 rotates, the pin work portion 10 can be driven to rotate.

In the embodiment, the pressing cylinder 626 is fixed at one side of the pin support 625. The output shaft of the pressing cylinder 626 is provided downward. Guide sleeve 6212 is provided at the other side of the pin support 625. Guide rod 6213 cooperating with the guide sleeve 6212 is provided on the pressing plate 627.

In a grabbing operation, the first motor 622 drives the pin work portion 10 to rotate and deflect to a preset angle, and the pin 628 grabs or places the sponge strip 71 conveniently from the elastic material cutting station 2 to a to-be-installed position of the flat die board 7.

When the sponge strip 71 is gabbed, the grabbing tool head 62 driven by the X/Y-axis feeding mechanism 4 moves to a position above the cut sponge strip 71. The first motor 622 drives the pin work portion 10 to rotate, such that the pin 628 is located fittingly above the cut sponge strip 71. The Z-axis feeding mechanism 5 drives the grabbing tool head 62 to move down, until the pin 628 is inserted into the sponge strip 71. The Z-axis feeding mechanism 5 drives the grabbing tool head 62 to move up, such that the cut sponge strip 71 leaves away from the elastic material cutting station 2.

When the sponge is grabbed, the discharge cylinder 623 can also drive the pin plate 624 to move down, such that the pin 628 is inserted into the sponge strip 71.

It is to be noted that when the sponge strip 71 is provided with the back glue, a frictional force between the pin 628 and the sponge strip 71 is greater than a viscous force of the back glue.

In the embodiment, a length of the pin 628 exposed out of the pressing plate 627 is greater than a thickness of the sponge strip 71.

When the sponge strip 71 is placed down, the grabbing tool head 62 driven by the X/Y-axis feeding mechanism 4 moves to a position above the to-be-installed position of the flat die board placement station 3. The first motor 622 drives the pin work portion 10 to rotate, such that the pin 628 is located fittingly above the to-be-installed position of the flat die board 7. The Z-axis feeding mechanism 5 drives the grabbing tool head 62 to move down, until the sponge strip 71 is placed on the to-be-installed position. The discharge cylinder 623 drives the pin 628 to move up, such that the pin 628 retracts to a position above the bottom of the pin support 625, and the pin 628 is separated from the sponge strip 71. The Z-axis feeding mechanism 5 drives the pin support 625 to move down. The bottom of the pin support 625 presses the sponge strip 71 on the flat die board 7. The grabbing tool head 62 moves up, thereby completing an installing operation. If the sponge strip 71 is not provided with the back glue, the to-be-installed position is subjected to a gluing operation through the gluing tool head before the installing operation.

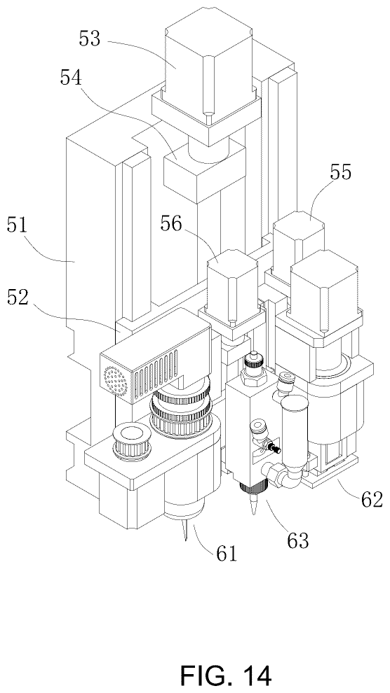

As shown in FIG. 14, the Z-axis feeding mechanism 5 includes Z-axis sliding seat 51, Z-axis sliding plate 52, and Z-axis drive motor 53. The Z-axis sliding seat 51 is fixed on the transverse support 42 of the X/Y-axis feeding mechanism 4. The Z-axis drive motor 53 and the Z-axis sliding plate 52 are provided on the Z-axis sliding seat 51. The Z-axis sliding seat 51 is in sliding fit with the Z-axis sliding plate 52. The Z-axis drive motor 53 is connected to the Z-axis sliding plate 52 through a lead screw nut transmission system. The Z-axis drive motor 53 drives the Z-axis sliding plate 52 to slide along a Z-axis direction.

The Z-axis feeding mechanism 5 further includes grabbing tool head lifting mechanism 55. The grabbing tool head lifting mechanism 55 is provided on the Z-axis sliding plate 52. The grabbing tool head 62 is provided at a movement output end of the grabbing tool head lifting mechanism 55.

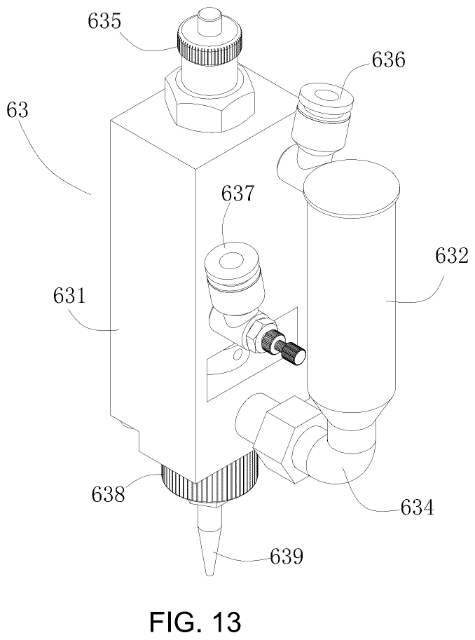

As shown in FIG. 13, the die rubber installing machine further includes gluing tool head 63. The gluing tool head 63 is liftable on the Z-axis feeding mechanism 5. The gluing tool head 63 is configured to perform the gluing operation on an installing position between the elastic material and the flat die board.

The gluing tool head 63 includes valve body 631. Glue injection cup 632 is connected to the valve body 631 through tube 634. Adjustment valve 635, air outlet connector 636, and air return connector 637 are provided on the valve body 631. A bottom of the valve body 631 is connected to glue outlet nozzle 639 through connecting nut 638.

When the sponge strip 71 is not provided with the back glue, the to-be-installed position of the flat die board 7 is glued first through the gluing tool head 63, such that the sponge strip 71 is installed on the flat die board 7 conveniently.

In the embodiment, the Z-axis feeding mechanism 5 further includes gluing tool head lifting mechanism 56. The gluing tool head lifting mechanism 56 is provided on the Z-axis sliding plate 52. The gluing tool head 63 is provided at a movement output end of the gluing tool head lifting mechanism 56.

Therefore, a height position of the grabbing tool head 62 and a height position of the gluing tool head 63 can be adjusted in the Z-axis direction.

There is at least one pin 628. As shown in FIG. 6 to FIG. 12, there may be two, three or four pins 628.

The pin 628 may be needle-like or flake-like. When the pin 628 is flake-like, the pin 628 may be square, rhombic, triangular, semicircular or elliptical. A tail end of the pin is tapered.

In the embodiment, the pins 628 may be provided on one or more modules. The module is detachably provided on the pin plate 624.

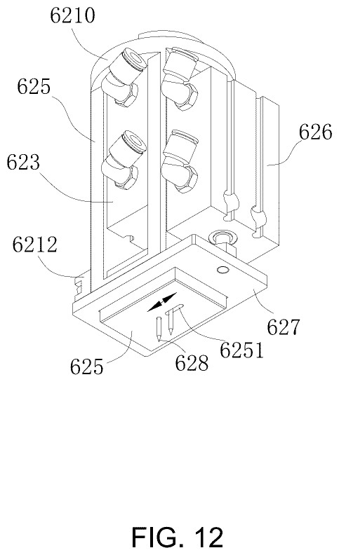

As shown in FIG. 12, when there are two or more pins 628, at least one of the pins 628 is movable left and right. For example, a clamping groove is formed in the module or the pin plate 624. A clamping member is provided at a front end of the pin 628. The clamping member is movable left and right in the clamping groove. Therefore, a distance between two pins 628 can be adjusted as required to adapt for sponge strips of different sizes and different shapes.

In other embodiments, the pin 628 is fixedly provided. The pin 628 may also be fixedly connected to the pin plate 624. A distance between the pins 628 cannot be adjusted. The pin 628 is directly fixed at the bottom of the pin plate 624 or fixed on the module, and may also be fixed on another connecting piece connected to the pin plate 624.

When the pin 628 is flake-like, even though there is one pin 628, the sponge strip 71 can also be driven well for angle adjustment, provided that the frictional force between the pin 628 and the sponge strip 71 is greater than the viscous force of the back glue of the sponge strip 71.

### Embodiment 2

Based on the die rubber installing machine provided by Embodiment 1, the embodiment provides an automatic die rubber installing method for a flat die board, including the following steps:

A preparing step: The elastic material and the to-be-installed flat die board are respectively placed on corresponding stations of the machine table 1.

A cutting step: The cutting tool head 61 is moved to the elastic material cutting station 2 to cut the elastic material into the elastic material strip of the preset shape and the preset size.

A gluing step: If the elastic material is not provided with the back glue, the gluing tool head 63 is moved to the flat die board placement station 3 to perform the gluing operation on the to-be-installed position of the die board.

An installing step: The grabbing tool head 62 grabs the elastic material strip, and moves the grabbed elastic material strip to the position above the to-be-installed position of the die board at the flat die board placement station 3. The grabbing tool head 62 is moved down. The elastic material strip is placed at the to-be-installed position of the die board and pressed. The grabbing tool head 62 is moved up. The elastic material strip is released.

In the embodiment, before the grabbing tool head 62 grabs the elastic material strip, the automatic die rubber installing method for a flat die board further includes: The pressing cylinder 626 drives the pressing plate 627 to press down, such that the elastic material is pressed flat. Then, the discharge cylinder 623 drives the pin 628 to move down. The pin 628 is inserted into the elastic material strip. The discharge cylinder 623 drives the pin 628 to move up. By this time, the elastic material strip moves up together. The Z-axis feeding mechanism 5 moves up, and the pressing cylinder 626 drives the pressing plate 627 to move up.

In the installing, the grabbing tool head 62 is moved to a position above the to-be-installed position of the flat die board 7. The first motor 622 is rotated, such that the pin 628 rotates together, and the elastic material strip corresponds to the to-be-installed position. The grabbing tool head 62 is moved down, such that the elastic material strip is installed on the to-be-installed position. The discharge cylinder 623 drives the pin 628 to move up, such that the pin 628 retracts into the pin support 625, and the pin 628 is separated from the sponge strip 71. The Z-axis feeding mechanism 5 drives the pin support 625 to move down. The bottom of the pin support 625 presses the sponge strip on the flat die board 7. The grabbing tool head 62 is moved up, thereby completing the installing operation.

### Embodiment 3

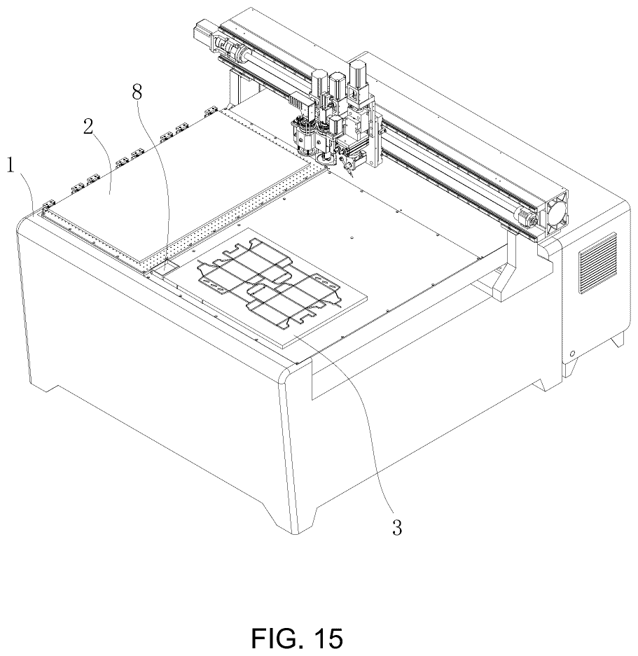

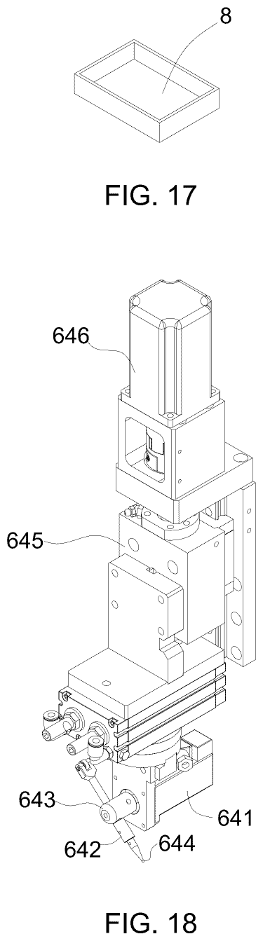

The automatic die rubber installing machine provided by the embodiment differs from the automatic die rubber installing machine in Embodiment 1 in: The gluing tool head is removed. As shown in FIG. 15 to FIG. 17, top-opened glue container 8 is provided on the machine table 1.

As shown in FIG. 15, the elastic material cutting station 2 and the flat die board placement station 3 are provided left and right on the machine table 1. The glue container 8 is provided outside or between the elastic material cutting station 2 and the flat die board placement station 3.

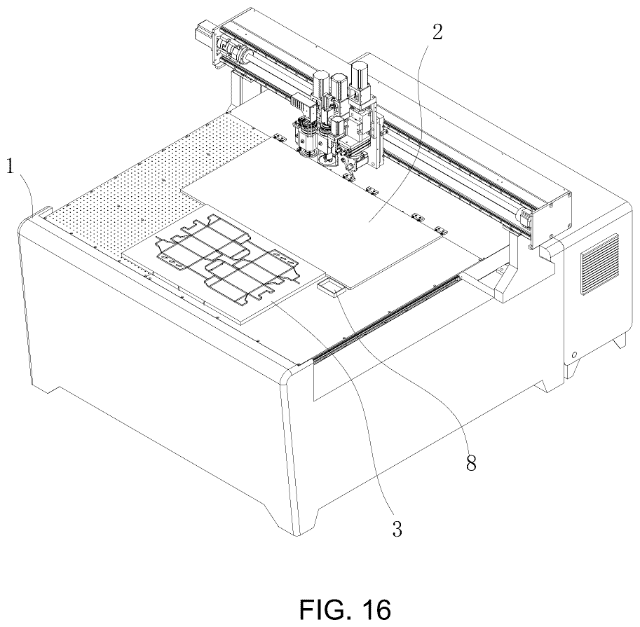

As shown in FIG. 16, the elastic material cutting station 2 and the flat die board placement station 3 are provided front and back on the machine table 1. The glue container 8 is provided outside or between the elastic material cutting station 2 and the flat die board placement station 3.

The glue container 8 is provided on the machine table 1 and at a corresponding position where the grabbing tool head 62 is allowed to reach.

The glue container 8 is provided on the machine table 1 and at a corresponding position where the grabbing tool head 62 is allowed to reach. A height of the glue container 8 is lower than an upper limit of a height moved by the grabbing tool head 62. In this way, the grabbing tool head can extend the grabbed elastic material strip into the glue container.

In other embodiments, the installing work portion may also be moved out of the machine table 1, and the glue container 8 may also be provided at a position outside the machine table 1, provided that the placement position of the glue container 8 does not affect a normal operation of the installing work portion.

The glue container 8 may be directly placed on the machine table 1, and may also be fixed on the machine table 1 by screwed connection, fastener fixation, magnetic suction or a magic tape.

The glue container 8 may be made of a plastic material, a metal material, a wood material, a stone material or a ceramic material, provided that the material does not react with the glue in the glue container.

A cross section of the glue container 8 is not limited, and may be a rectangle, a circle, a square or other irregular shapes, provided that the size of the cross section is greater than the size of the cut elastic material to be dipped with the glue.

Other contents are the same as those in Embodiment 1, and are not repeated herein.

### Embodiment 4

Based on the die rubber installing machine provided by Embodiment 3, the embodiment provides an automatic die rubber installing method for a flat die board. The die rubber installing method in the embodiment differs from the die rubber installing method in Embodiment 2 in a gluing step and an installing step.

The gluing step: If the elastic material is not provided with the back glue, the grabbing tool head 62 grabs the elastic material strip, and extends the elastic material strip into the glue container 8. The glue is dipped to a bottom and/or a part of a periphery of the elastic material strip.

The installing step: The grabbing tool head 62 moves a grabbed elastic material strip to a position above the to-be-installed position of the die board at the flat die board placement station 3. The grabbing tool head 62 is moved down. The elastic material strip is placed at the to-be-installed position of the die board and pressed. The grabbing tool head 62 is moved up. The elastic material strip is released.

After the part of the periphery of the elastic material strip is dipped with the glue, and the elastic material strip is installed on the flat die board, sidewalls of adjacent elastic materials are connected as a whole. For past gluing methods, the glue can only be dipped at limited positions of the flat die board, and when the elastic material strip is pressed on the flat die board, the glue exists between some positions and the flat die board to cause unstable and unreliable installing quality. In the present disclosure, the elastic material is extended into the glue container 8 through the grabbing tool head 62, such that the glue is dipped to the bottom and/or the part of the periphery of the elastic material. Therefore, the elastic material and the flat die board are installed firmly and stably. Meanwhile, the elastic material and the adjacent elastic material are also installed together as a whole, which further improves a glue strength.

Other contents are the same as those in Embodiment 2, and are not repeated herein.

### Embodiment 5

In any embodiment from Embodiment 1 to Embodiment 4, in order that the grabbing tool head 62 can accurately install the elastic material strip on the flat die board, there is a need to acquire positional data of the flat die board and a cutter seam on the machine table, as well as height data of the upper surface of the flat die board relative to the surface of the machine table.

In view of this, on the basis of Embodiment 1, Embodiment 2, Embodiment 3 or Embodiment 4, the embodiment provides a die rubber installing machine for a flat die board. The installing work portion of the die rubber installing machine further includes detection tool head 64. The detection tool head 64 can detect the positional data of the flat die board and the cutter seam, as well as the height data of the upper surface of the flat die board relative to the surface of the machine table.

As shown in FIG. 18, the detection tool head 64 includes rotary detection motor 641 and probe 642. Rotating shaft 643 of the rotary detection motor 641 is provided horizontally. The probe 642 is fixedly connected to the rotating shaft 643 of the rotary detection motor 641 and crossed with the rotating shaft 643 of the rotary detection motor 641. Detection head 644 is provided at a tail end of the probe 642.

Preferably, the die rubber installing machine for a flat die board further includes a detection tool head lifting mechanism. The detection tool head lifting mechanism includes lifting platform 645 and lifting detection motor 646. The lifting platform 645 and the lifting detection motor 646 are provided at a movement output end of the Z-axis feeding mechanism 5. The lifting detection motor 646 is connected to the lifting platform 645. The lifting detection motor 646 is configured to drive the lifting platform 645 to move up and down. The rotary detection motor 641 is provided on the lifting platform 645.

In other implementations, the lifting platform may also be driven in a manner including but not limited to a cylinder, a hydraulic cylinder or manual pushing. Other driving manners that can drive the lifting platform 645 to move up or down also fall into the technical solutions in the embodiment.

The detection head 644 is a ball head configured to detect an actual position of the cutter seam. A diameter of the ball head is greater than a width of a to-be-detected cutter seam. Since the diameter of the ball head is greater than the width of the to-be-detected cutter seam, when the ball head slides over the to-be-detected cutter seam, the ball head can slide over the cutter seam easily, without being caught or clamped in the cutter seam.

In use, in response to a maximum rotating angle of the rotating shaft 643 of the rotary detection motor 641, a lowest point of the ball head falls on a centerline of the cutter seam certainly. Regardless of whether the ball head slides over the cutter seam perpendicularly or in an included angle, in response to the maximum rotating angle of the rotating shaft 643 of the rotary detection motor 641, the lowest point of the ball head falls on the centerline of the cutter seam certainly.

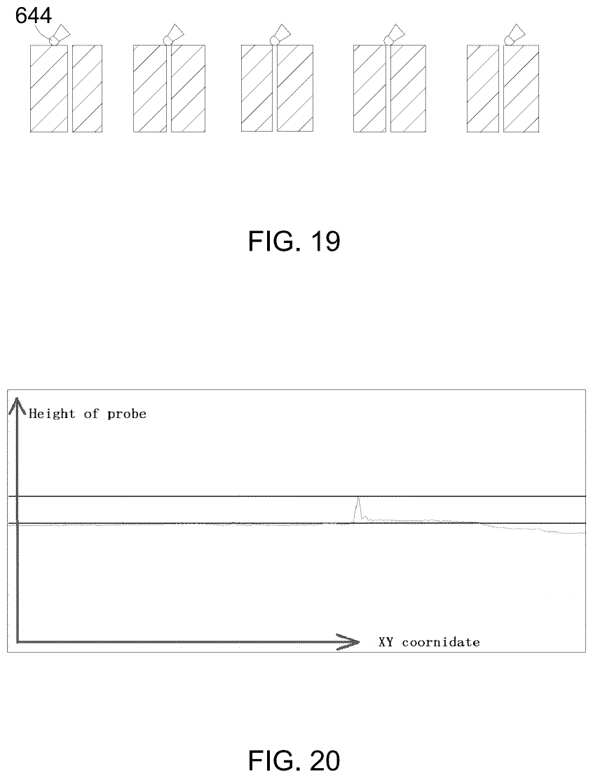

FIG. 19 illustrates a detection process of the cutter seam in the embodiment. From left to right, the detection process sequentially includes time when the ball head contacts a plane of the flat die board, time when the ball head contacts a vertex angle at one side of the cutter seam, time when the ball head contacts vertex angles at two sides of the cutter seam at the same time, time when the ball head contacts a vertex angle at the other side of the cutter seam, and time when the ball head contacts the plane of the flat die board again. Obviously, when the ball head contacts the vertex angles at the two sides of the cutter seam at the same time, the lowest point of the ball head falls on the centerline of the cutter seam, or, the lowest point of the ball head falls on a central plane of the centerline of the cutter seam.

Based on the detection tool head 64, a position of the flat die board and a position of the cutter seam are detected, which includes the following steps:

S1: The detection tool head 64 is moved. The detection head 644 is pressed on the upper surface of the target flat die board at the flat die board placement station 3. A rotating position of the rotating shaft 643 of the rotary detection motor 641 is recorded as an initial position.

S2: The detection tool head 64 is horizontally moved, such that the detection head 644 slides over the cutter seam. A rotating position of the rotating shaft 643 of the rotary detection motor 641 is recorded in this process. A rotating position curve is obtained. A point position on the cutter seam is determined according to a peak on the rotating position curve.

S3: The S2 is repeated to obtain two point positions on the same cutter seam, thereby obtaining a centerline parameter of the cutter seam. The S2 and the S3 are repeated to obtain centerline parameters of at least one pair of crossed cutter seams.

S4: The centerline parameters of the at least one pair of crossed cutter seams are compared with a parameter of a cutter seam of the target flat die board in a database to obtain an actual position of the target flat die board and an actual position of the cutter seam.

Specifically, the parameter of the cutter seam of the target flat die board in the database includes: a centerline parameter of the cutter seam when the target flat die board is located at a standard position on the machine table 1.

Specifically, as shown in FIG. 20, the curve is smooth relatively all the time, and there is only one position with a most prominent fluctuated peak. The peak point represents an extremum, namely a lowest position reached when the ball head passes through the cutter seam. The lowest position falls on the centerline of the cutter seam.

The actual centerline parameters of the at least one pair of crossed cutter seams are obtained. That is, a crossed angle between two cutter seams is obtained. With the addition of XY-axis coordinates of at least two points on the two cutter seams, the actual position of the present cutter seam can be obtained.

Based on the detection tool head 64, the height of the upper surface of the flat die board relative to the surface of the machine table is detected, which includes the following steps:

A1: The detection tool head is moved. After the detection head 644 contacts the surface of the machine table, a height position Z₁ of the rotary detection motor 641 and a deflection angle W₁ of the rotating shaft 643 of the rotary detection motor 641 are obtained.

A2: The detection tool head is moved. After the detection head 644 contacts the upper surface of the flat die board, a height position Z₂ of the rotary detection motor 641 and a deflection angle W₂ of the rotating shaft 643 of the rotary detection motor 641 are obtained.

A3: It is assumed that a length between a center of the detection head 644 to a center of the rotating shaft 643 of the rotary detection motor 641 is L, a Z-direction distance between the center of the detection head 644 and the center of the rotating shaft 643 of the rotary detection motor 641 in the A1 is H₁, and a Z-direction distance between the center of the detection head 644 and the center of the rotating shaft 643 of the rotary detection motor 641 in the A2 is H₂, then a height H−(Z₂−H₂)−(Z₁−H₁) of the flat die board is obtained.

The Z-direction distance between the center of the detection head 644 and the center of the rotating shaft 643 of the rotary detection motor 641 in the A1 is H₁=sinW₁*L. The Z-direction distance between the center of the detection head 644 and the center of the rotating shaft 643 of the rotary detection motor 641 in the A2 is H₂=sinW₂*L.

When the deflection angle W₁ of the rotating shaft 643 in the A1 is the same as the deflection angle W₂ of the rotating shaft 643 of the rotary detection motor 641 in the A2, a height difference between the upper surface of the flat die board and the surface of the machine table is H=Z₂−Z₁.

When the deflection angle W₁ of the rotating shaft 643 in the A1 is not the same as the deflection angle W₂ of the rotating shaft 643 in the A2, a height difference between the upper surface of the flat die board and the surface of the machine table is H=Z₂−Z₁+sinW₁*L−sinW₂*L.

In the A2, by allowing the detection head 644 to contact different positions on the upper surface of the flat die board, obtaining a plurality of Z₂, and seeking an average Z₂′, H=Z₂−Z₁. Specifically, the Z₁ is a height position of the rotary detection motor 641 when the detection head 644 contacts the surface of the machine table. Due to a high planeness of the surface of the machine table, when the detection head 644 contacts different positions, the Z₁ is unchanged provided that the W₁ is the same. Certainly, the Z₁ may also be obtained in a manner that is similar to the manner of the Z₂ for seeking the average Z₂.

In the A2, by allowing the detection head 644 to contact different positions on the upper surface of the flat die board, obtaining a plurality of Z₂, seeking an average Z₂′, obtaining a plurality of W₂ and seeking an average W₂′, H=Z₂′−Z₁+sinW₁*L−sinW₂*L. For example, eight Z₂ may be obtained at different positions on the upper surface of the flat die board, and an average is sought. Specifically, the Z₁ is a height position of the rotary detection motor 641 when the detection head 644 contacts the surface of the machine table. Due to a high planeness of the surface of the machine table, when the detection head 644 contacts different positions, the Z₁ is unchanged provided that the W₁ is the same. Since there may be a deviation at different positions on the upper surface of the flat die board, the H is obtained by adding sinW₁*L to the average for a plurality of H₀, and subtracting sinW₂′*L, H₀=Z₂−Z₁.

In an implementation process of the embodiment, there are two cases in total. In a first case, the rotating shaft 643 of the rotary detection motor 641 keeps the same angle in the A1 and the A2. In a second case, the rotating shaft 643 of the rotary detection motor 641 has different deflection angles in the A1 and the A2.

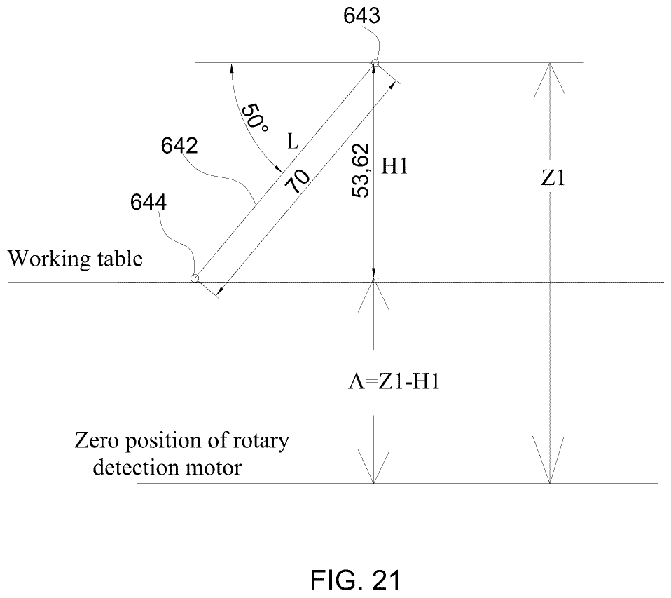

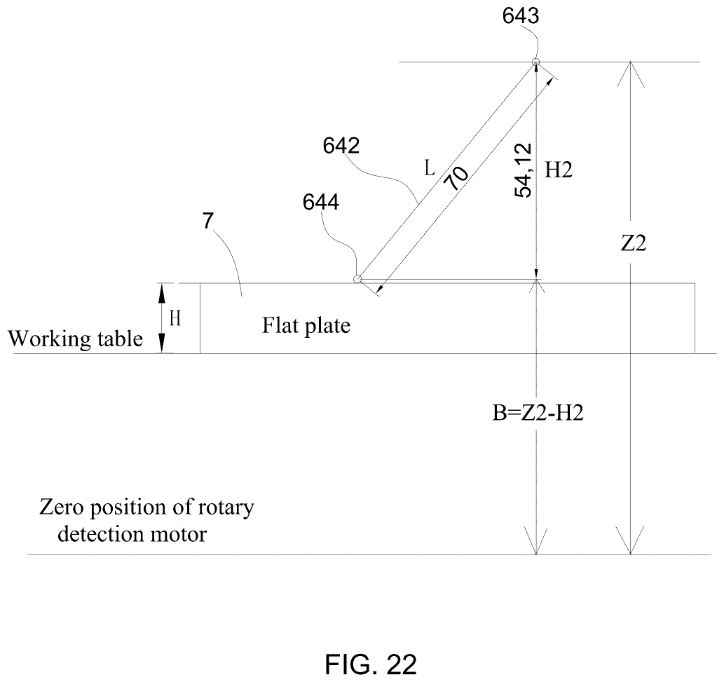

In the first case, as shown in FIG. 21 and FIG. 22, it is assumed that the W₁ is 50°, the W₂ is the same as the W₁, the Lis 70 mm, and the H₀ is 17.50 mm. In this case, the rotating shaft 643 of the rotary detection motor 641 keeps the same angle in the A1 and the A2.

The height difference H=Z₂−Z₁ between the surface of the machine table and the upper surface of the flat die board is the same H₀+H₁−H₂. Due to H₁=H₂, H=H₀, and the height difference H between the surface of the machine table and the upper surface of the flat die board is 17.50 mm.

In the second case, as shown in FIG. 21 and FIG. 22, it is assumed that the W₁ is 50°, the W₂ is 50.641°, the L is 70 mm, and the H₀ is 18 mm. In this case, the rotating shaft 643 of the rotary detection motor 641 has different deflection angles in the A1 and the A2.

The height difference H=Z₂−Z₁+sinW₁*L−sinW₂*L between the surface of the machine table and the upper surface of the flat die board is the same as Z₂−Z₁+sinW₁*L−sinW₂*L, and is 53.623−54.123+18. The height difference H between the surface of the machine table and the upper surface of the flat die board is 17.499980 mm.

It should be understood that in the description of the present disclosure, terms such as “first” and “second” are used merely for a descriptive purpose, and should not be construed as indicating or implying relative importance, or implicitly indicating a quantity of indicated technical features. Thus, features defined with “first” and “second” may explicitly or implicitly include one or more of the features. In the description of the present disclosure, “a plurality of” means two or more, unless otherwise specifically defined.

In the present disclosure, unless otherwise clearly specified, the terms “installation”, “interconnection”, “connection” and “fixation” etc. are intended to be understood in a broad sense. For example, the “connection” may be a fixed connection, removable connection or integral connection; may be a mechanical connection or electrical connection; may be a direct connection or indirect connection using a medium; and may be a communication or interaction between two elements. Those of ordinary skill in the art may understand specific meanings of the above terms in the present disclosure based on a specific situation.

In the present disclosure, unless otherwise clearly specified and limited, when it is described that a first feature is “above” or “below” a second feature, it indicates that the first and second features are in direct contact or the first and second features are in indirect contact through a medium. In addition, when it is described that the first feature is “over”, “above”, and “on” the second feature, it indicates that the first feature is directly or obliquely above the second feature, or simply indicates that the first feature is higher than the second feature. When it is described that a first feature is “under”, “below” or “beneath” a second feature, it indicates that the first feature is directly or obliquely under the second feature or simply indicates that the first feature is lower than the second feature.

In the description of this specification, the description with reference to the terms such as “one embodiment”, “some embodiments”, “example”, “specific example” or “some examples” means that specific features, structures, materials or characteristics described in connection with the embodiment or example are included in at least one embodiment or example of the present disclosure. In this specification, the schematic expression of the above terms is not necessarily directed to the same embodiment or example. Furthermore, the specific features, structures, materials, or characteristics described may be combined in a suitable manner in any one or more of embodiments or examples. In addition, those skilled in the art may combine different embodiments or examples described in this specification and characteristics of the different embodiments or examples without mutual contradiction.

Although the embodiments of the present disclosure have been illustrated and described above, it will be appreciated that the above embodiments are illustrative and should not be construed as limiting the present disclosure. Changes, modifications, substitutions, and variations can be made to the above embodiments by a person of ordinary skill in the art within the scope of the present disclosure.

1. An automatic die rubber installing machine for a flat die board, comprising:
a machine table, wherein an elastic material cutting station and a flat die board placement station are provided on the machine table;
an XY-axis feeding mechanism provided on the machine table, and located above the elastic material cutting station and the flat die board placement station;
a Z-axis feeding mechanism provided on the XY-axis feeding mechanism; and
an installing work portion provided at a movement output end of the Z-axis feeding mechanism, configured to move up and down under drive of the Z-axis feeding mechanism, and configured to move between the elastic material cutting station and the flat die board placement station under drive of the XY-axis feeding mechanism;
wherein the installing work portion comprises a cutting tool head and a grabbing tool head; the cutting tool head and the grabbing tool head are configured to rotate around a Z axis; the cutting tool head is configured to cut an elastic material into an elastic material strip at the elastic material cutting station; and the grabbing tool head is configured to grab the elastic material strip, move the elastic material strip from the elastic material cutting station to the flat die board placement station, and fix the elastic material strip at a to-be-installed position of a die board at the flat die board placement station.

2. The automatic die rubber installing machine for the flat die board according to claim 1, wherein the grabbing tool head comprises a first revolving seat; and a pin work portion driven by a first motor and rotating around the Z axis is provided on the first revolving seat; and
the pin work portion comprises a discharge cylinder, a pin support, and a grabbing actuation end; the pin support is connected to the first motor; the discharge cylinder is provided on the pin support; the grabbing actuation end is fixedly connected to an output shaft of the discharge cylinder; and an avoidance position is provided at a bottom of the pin support and configured to allow the grabbing actuation end to extend and retract up and down.

3. The automatic die rubber installing machine for the flat die board according to claim 2, wherein the pin work portion further comprises a pressing cylinder and a pressing plate; the pressing cylinder is provided on the pin support; the pressing plate is fixedly connected to an output shaft of the pressing cylinder; and a through hole is formed in the pressing plate and configured to avoid the bottom of the pin support when the pressing plate extends and retracts up and down.

4. The automatic die rubber installing machine for the flat die board according to claim 2, wherein the grabbing actuation end comprises a pin plate and pins provided at a bottom of the pin plate; and the pin plate is fixedly connected to the output shaft of the discharge cylinder.

5. The automatic die rubber installing machine for the flat die board according to claim 4, wherein the pins are fixedly provided at the bottom of the pin plate; and alternatively,
there are two or more pins, and at least one of the two or more pins is movable left and right at the bottom of the pin plate.

6. The automatic die rubber installing machine for the flat die board according to claim 1, wherein the installing work portion further comprises a detection tool head; and
the detection tool head comprises a rotary detection motor and a probe; a rotating shaft of the rotary detection motor is provided horizontally; the probe is fixedly connected to the rotating shaft of the rotary detection motor and crossed with the rotating shaft of the rotary detection motor; and a detection head is provided at a tail end of the probe.

7. The automatic die rubber installing machine for the flat die board according to claim 6, further comprising a detection tool head lifting mechanism, wherein the detection tool head lifting mechanism is provided at the movement output end of the Z-axis feeding mechanism; and the rotary detection motor is provided at a movement output end of the detection tool head lifting mechanism.

8. The automatic die rubber installing machine for the flat die board according to claim 1, wherein the installing work portion further comprises a gluing tool head; the gluing tool head is liftable relative to the Z-axis feeding mechanism; and the gluing tool head is configured to perform a gluing operation on an installing position between the elastic material and the flat die board.

9. The automatic die rubber installing machine for the flat die board according to claim 1, wherein a top-opened glue container is provided on the machine table; the top-opened glue container is located at a position where the grabbing tool head is allowed to reach; and the grabbing actuation end of the grabbing tool head is configured to extend into the top-opened glue container.

10. The automatic die rubber installing machine for the flat die board according to claim 1, wherein the cutting tool head comprises a second revolving seat, a vibration drive assembly, a cutter, and a second motor; the cutter is rotatably provided on the second revolving seat; the vibration drive assembly is provided on the second revolving seat, and connected to the cutter; the vibration drive assembly is configured to drive the cutter to vibrate up and down; the second motor is provided on the second revolving seat, and connected to the cutter; and the second motor is configured to drive the cutter to rotate around the Z axis.

11. An automatic die rubber installing method for a flat die board, wherein the automatic die rubber installing method for the flat die board is realized based on an automatic die rubber installing machine for the flat die board; the automatic die rubber installing machine for the flat die board comprises a machine table and an installing work portion; an elastic material cutting station and a flat die board placement station are provided on the machine table; the installing work portion is movably provided on the machine table, and faces toward the elastic material cutting station and the flat die board placement station; and the installing work portion comprises a cutting tool head and a grabbing tool head, wherein the cutting tool head and the grabbing tool head are configured to rotate around a Z axis; and
the automatic die rubber installing method for the flat die board comprises the following steps:
a cutting step: moving the cutting tool head to the elastic material cutting station to cut an elastic material into an elastic material strip of a preset shape and a preset size; and
an installing step: allowing the grabbing tool head to move a grabbed elastic material strip to a position above a to-be-installed position of a die board at the flat die board placement station; and moving down the grabbing tool head, placing the elastic material strip at the to-be-installed position of the die board and pressing the elastic material strip, moving up the grabbing tool head, and releasing the elastic material strip.

12. The automatic die rubber installing method for the flat die board according to claim 11, further comprising a gluing step between the cutting step and the installing step, wherein
the gluing step is realized based on a gluing tool head comprised in the installing work portion, and comprises: moving the gluing tool head to the flat die board placement station, and performing a gluing operation at the to-be-installed position of the die board; and alternatively,
the gluing step is realized based on a top-opened glue container provided on the machine table, and comprises: allowing the grabbing tool head to grab the elastic material strip, and extend the elastic material strip into the top-opened glue container, wherein a glue is dipped to a bottom and/or a part of a periphery of the elastic material strip.

13. The automatic die rubber installing method for the flat die board according to claim 11, wherein the grabbing tool head comprises a pin support, a discharge cylinder and a grabbing actuation end, wherein the discharge cylinder and the grabbing actuation end are supported on the pin support; and the grabbing actuation end is fixedly connected to an output shaft of the discharge cylinder; and
the steps of moving down the grabbing tool head, placing the elastic material strip at the to-be-installed position of the die board and pressing the elastic material strip comprise: extending out the grabbing actuation end at a bottom of the pin support to grab the elastic material strip; moving down the grabbing tool head to drive the grabbing actuation end to place the elastic material strip at the to-be-installed position of the die board; allowing the discharge cylinder to drive the grabbing execution end to move up to a position higher than the bottom of the pin support; and continuously moving down the grabbing tool head, such that the pin support is driven to move down and the bottom of the pin support is pressed on the elastic material strip.

14. The automatic die rubber installing method for the flat die board according to claim 11, further comprising a detecting step before the cutting step, wherein
the detecting step is realized based on a detection tool head comprised in the installing work portion; the detection tool head comprises a rotary detection motor and a probe; a rotating shaft of the rotary detection motor is provided horizontally; the probe is fixedly connected to the rotating shaft of the rotary detection motor and crossed with the rotating shaft of the rotary detection motor; and a detection head is provided at a tail end of the probe; and
the detecting step comprises:
S1: moving the detection tool head, pressing the detection head on an upper surface of a target flat die board at the flat die board placement station, and recording a rotating position of the rotating shaft of the rotary detection motor as an initial position;
S2: horizontally moving the detection tool head, such that the detection head slides over a cutter seam, recording a rotating position of the rotating shaft of the rotary detection motor in this process, obtaining a rotating position curve, and determining a point position on the cutter seam according to a peak in the rotating position curve;
S3: repeating the step S2 to obtain two point positions on the same cutter seam, thereby obtaining a centerline parameter of the cutter seam; and repeating the step S2 and the step S3 to obtain centerline parameters of at least one pair of crossed cutter seams; and
S4: comparing the centerline parameters of the at least one pair of crossed cutter seams with a parameter of a cutter seam of the target flat die board in a database to obtain an actual position of the target flat die board and an actual position of the cutter seam.

15. The automatic die rubber installing method for the flat die board according to claim 11, further comprising a detecting step before the cutting step, wherein
the detecting step is realized based on a detection tool head comprised in the installing work portion; the detection tool head comprises a rotary detection motor and a probe; a rotating shaft of the rotary detection motor is provided horizontally; the probe is fixedly connected to the rotating shaft of the rotary detection motor and crossed with the rotating shaft of the rotary detection motor; and a detection head is provided at a tail end of the probe; and
the detecting step comprises:
A1: moving the detection tool head, and after the detection head contacts a surface of the machine table, obtaining a height position Z₁ of the rotary detection motor and a deflection angle W₁ of the rotating shaft of the rotary detection motor;
A2: moving the detection tool head, and after the detection head contacts an upper surface of the flat die board, obtaining a height position Z₂ of the rotary detection motor and a deflection angle W₂ of the rotating shaft of the rotary detection motor; and
A3: assuming that a length between a center of the detection head to a center of the rotating shaft of the rotary detection motor is L, a Z-direction distance between the center of the detection head and the center of the rotating shaft of the rotary detection motor in the step A1 is H₁, and a Z-direction distance between the center of the detection head and the center of the rotating shaft of the rotary detection motor in the step A2 is H₂, then obtaining a height H=(Z₂−H₂)−(Z₁−H₁) of the flat die board.

16. The automatic die rubber installing method for the flat die board according to claim 14, further comprising a detecting step before the cutting step, wherein
the detecting step is realized based on a detection tool head comprised in the installing work portion; the detection tool head comprises a rotary detection motor and a probe; a rotating shaft of the rotary detection motor is provided horizontally; the probe is fixedly connected to the rotating shaft of the rotary detection motor and crossed with the rotating shaft of the rotary detection motor; and a detection head is provided at a tail end of the probe; and
the detecting step comprises:
A1: moving the detection tool head, and after the detection head contacts a surface of the machine table, obtaining a height position Z₁ of the rotary detection motor and a deflection angle W₁ of the rotating shaft of the rotary detection motor;
A2: moving the detection tool head, and after the detection head contacts an upper surface of the flat die board, obtaining a height position Z₂ of the rotary detection motor and a deflection angle W₂ of the rotating shaft of the rotary detection motor; and
A3: assuming that a length between a center of the detection head to a center of the rotating shaft of the rotary detection motor is L, a Z-direction distance between the center of the detection head and the center of the rotating shaft of the rotary detection motor in the step A1 is H₁, and a Z-direction distance between the center of the detection head and the center of the rotating shaft of the rotary detection motor in the step A2 is H₂, then obtaining a height H=(Z₂−H₂)−(Z₁−H₁) of the flat die board.
